(19) United States
(12) Patent Application Publication
(10) Pub. No.: US 2005/0010392 A1
(43) Pub. Date: Jan. 13, 2005

(54) Traditional Chinese / simplified Chinese character translator

(75) Inventors: Yen-Fu Chen, Austin, TX (US); John W. Dunsmoir, Round Rock, TX (US)

Correspondence Address: Rudolf O. Siegesmund, Suite 2000, 4627 N. Central Expressway, Dallas, TX, 75205-4017, US

(73) Assignee: International Business Machines Corporation, Armonk, NY (US)

(21) Appl. No.: 10/617,530

(22) Filed: Jul. 10, 2003

(51) Int. Cl. G06F 17/20

(52) U.S. Cl. 704/8

(57) ABSTRACT

A method for translating a Simplified Chinese character into a Traditional Chinese character and vice-versa is disclosed. The present invention comprises a Character Conversion Program (CCP). The CCP accepts a character in Big 5, GB2312, or any Unicode encoding scheme and translates the character into Unicode. If the entered character is a Simplified Chinese character, then the CCP determines the Traditional Chinese character equivalent. If the entered character is a Traditional Chinese character, then the CCP determines the Simplified Chinese character equivalent. The CCP then displays the entered Simplified Chinese character and the equivalent Traditional Chinese character, or vice-versa. If the entered character is a Traditional Chinese character and does not have a Simplified Chinese equivalent, then the CCP displays a message indicating that the Traditional Chinese character does not have a Simplified Chinese equivalent.

### FIELD OF THE INVENTION

The present invention is directed to a method translating Simplified Chinese characters into Traditional Chinese characters and vice-versa.

### BACKGROUND OF THE INVENTION

Sino-Tibetan based languages, such as Chinese, are vastly different than Latin based languages such as English. The Chinese language does not contain an alphabet. Instead, the Chinese language comprises more than 60,000 individual characters. Each of the 60,000 characters has a different meaning. Knowledge of about 1,200 characters is sufficient to read a Chinese newspaper. Chinese college graduates know about 3,000 characters.

Chinese also differs from Latin based languages in the concept of a word. In Chinese, strings of characters do not contain spaces and the interpretation of where one word ends and another starts is entirely based on context. Chinese characters are very precise in meaning, pronunciation, and in the way they are written. If a Chinese character has characters added to it in a string, the meaning of the first character is enhanced, but normally it is not changed.

Chinese characters are always pronounced as a single syllable. There are no two-syllable Chinese characters. Each Chinese character has one of five fundamental sounds. These five fundamental sounds give a singing quality to Chinese because some characters are pronounced with high tones, some with low tones, and some with tones that are rising or falling. Tone is fundamental to the language and Chinese would not be readily understood without the tones. For example, the character “ma” can either mean “mother” or “horse” or a “question” depending the tone. In China many dialects are spoken. Spoken words are almost unintelligible for one dialect to the next. However, there is only one written Chinese. Written Chinese is understood by all dialects. Other Sino-Tibetan languages such as Japanese, Korean, and Vietnamese use several characters common to Chinese. However, these languages have no common written or spoken meaning, similar to the manner in which English, Spanish, and French use a common alphabet but are not otherwise interchangeable.

Following the Chinese Communist revolution in 1949, the Communist party made several changes to the Chinese language. First, the traditional method of writing Chinese from “top to bottom” and “right to left” was abandoned. The Peoples' Republic of China (PRC or mainland China) now follows Western languages and is written from “left to right” and then “top to bottom.” Second, a single dialect was chosen, Mandarin, which is now taught in all schools as the primary Chinese language. Third, the PRC altered about one quarter of the characters to reduce them to around seven lines or strokes. This form of Chinese is called “Simplified Chinese.” In the PRC, Simplified Chinese is now widely used, but the Republic of China (ROC or Taiwan) and Hong Kong still use the more elaborate form of Chinese called “Traditional Chinese.” The PRC also adopted the Hindu-Arabic numbering system used by most Western countries and the advent of the Internet is causing English to appear in many Chinese sentences.

The PRC also introduced “Pin Yin,” a phonetic version of Chinese to help young children learn the language. Pin Yin uses the 26 letters of the English alphabet plus 4 accents over certain vowels to indicate how the character should be pronounced. Pin Yin is normally used from about 4 years of age until around 7 years of age when the students are taught to use Chinese Characters. Pin Yin is also very helpful for tourists and businessmen to speak Chinese from phrase books. Additionally, Pin Yin is popular with computer users as it is the easiest way to enter Chinese characters from a keyboard.

In the computer, all Sino-Tibetan languages are represented by 16-bit characters, while English and the other Latin languages are represented by 8-bit characters. Traditionally, separate encodings were produced for each of the languages. English and the other Latin languages use ASCII encoding; Simplified Chinese uses GB2312 encoding, Traditional Chinese uses Big 5 encoding, and so forth. In other words, a computer using Big 5 encoding cannot read computer code in GB2312 or ASCII encoding. This multiplicity of encodings is confusing and there is no standardization between the different encodings. The Unicode consortium has developed a single encoding that incorporates all the major languages of the world. There is a strong movement to use Unicode and replace all the other encodings in computer applications. Unicode uses 16 bits for each character inside the computer. Unicode has 65,000 different characters and each of the major languages is mapped into a different section of this Unicode range. Consequently, Unicode can be used as a single encoding scheme for all of the world's languages.

One of the problems with Unicode, however, is that individual characters, letters, or symbols can be represented using different schemes within Unicode. Two of the most popular encoding schemes are UTF-8 and UCS-2. UTF-8 is a binary (base-2) Unicode encoding scheme which represents each character, letter, or symbol as one, two, or three bytes, each byte being eight bits. In contrast, UCS-2 is a hexadecimal (base-16) Unicode encoding scheme which represents each character, letter, or symbol as eight hexadecimal digits. One hexadecimal digit is equivalent to 4 bits, and 1 byte can be expressed by two hexadecimal digits. Table 1 below displays the difference between UTF-8 and UCS-2.

TABLE 1

| UCS-2 | | |
|---|---|---|
| (Hexadecimal) | UTF-8 (Binary) | Description |
| 0000 007F | 0xxxxxxx | ASCII |
| 0080 07FF | 110xxxxx 10xxxxxx | Up to U + 07FF |
| 0800 FFFF | 1110xxxx 10xxxxxx 10xxxxxx | Other UCS-2 |

A user may choose to encode using the UCS-2 scheme or the UTF-8 scheme depending on the user's expected needs. For example, when transmitting data from one location to another, UTF-8 is the preferred encoding scheme due to the transmission efficiency inherent in variable byte stream length (i.e. 1-3 bytes, as shown in Table 1). However, when storing the same information in a database, UCS-2 is the preferred encoding scheme because the uniform data length allows for faster search and comparison operations (i.e. 8 hexadecimal digits, as shown in Table 1). Conversion functions between UCS-2 and UTF-8 are available as evidenced by United States Patent Application Publication 2003/0078921 entitled “Table-Level Unicode Handling in a Database Engine,” incorporated herein by reference.

Prior to the development of Unicode, a computerized character translator between Simplified Chinese and Traditional Chinese was impossible because of the inability of GB2312 code to understand Big 5 code, and vice-versa. Users who needed a translation from Simplified Chinese to Traditional Chinese or vice-versa were forced to look up the translation in a printed dictionary. If the user desired a computer-implemented translation, the user was forced to use Pin Yin, English, or some other language as an intermediary between Simplified Chinese and Traditional Chinese. Therefore, a need exists for an automated method for directly translating between Traditional Chinese and Simplified Chinese. Similarly, a need exists for a computerized method for translating between Simplified Chinese and traditional Chinese utilizing Unicode.

### SUMMARY OF THE INVENTION

The present invention is a methodology for translating a Simplified Chinese character into a Traditional Chinese character and vice-versa. The software embodiment of the present invention is a computer program operable on a web page or as a program on a stand-alone computer. The software embodiment of the present invention comprises a Character Conversion Program (CCP). The CCP accepts a character in Big 5, GB2312, or any Unicode encoding scheme and translates the character into Unicode. The CCP then determines if the character is a Simplified Chinese character or a Traditional Chinese character. If the entered character is a Simplified Chinese character, then the CCP uses the Simplified Chinese/Traditional Chinese Conversion Table to determine the Traditional Chinese character equivalent. If the entered character is a Traditional Chinese character, then the CCP uses the Simplified Chinese/Traditional Chinese Conversion Table to determine the Simplified Chinese character equivalent. The CCP then displays the entered Simplified Chinese character and the equivalent Traditional Chinese character, or vice-versa. If the entered character is a Traditional Chinese character and does not have a Simplified Chinese equivalent, then the CCP displays a message indicating that the Traditional Chinese character does not have a Simplified Chinese equivalent.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a computer network used to implement the present invention;

FIG. 2 is an illustration of the memory used to implement the present invention;

FIG. 3 is an illustration of the logic of the Character Conversion Program (CCP) of the present invention; and

FIG. 4 is an illustration of the graphical user interface (GUI) of the present invention.

### DETAILED DESCRIPTION OF THE PREFERRED EMBODIMENT

As used herein, the term “Big 5” means the encoding language for the Traditional Chinese character set.

As used herein, the term “computer” shall mean a machine having a processor, a memory, and an operating system, capable of interaction with a user or other computer, and shall include without limitation desktop computers, notebook computers, personal digital assistants (PDAs), servers, handheld computers, and similar devices.

As used herein, the term “GB2312” means the encoding language for the Simplified Chinese character set.

As used herein, the term “Unicode” means the encoding language developed by the Unicode consortium comprising most of the world's languages including the Simplified Chinese character set and the Traditional Chinese character set.

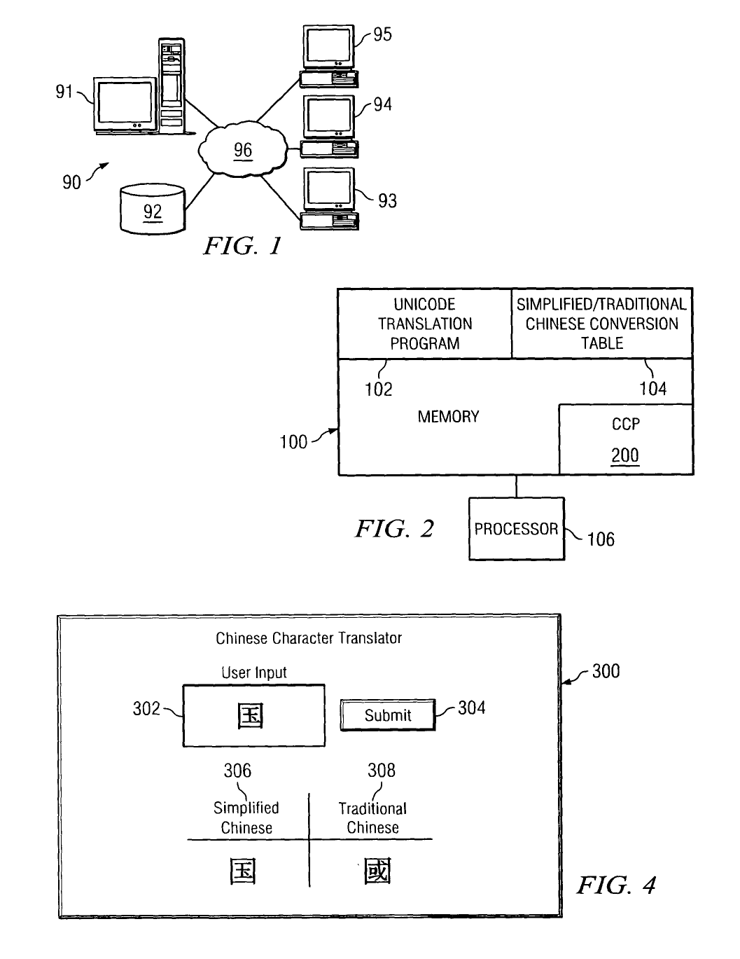

FIG. 1 is an illustration of computer network 90 associated with the present invention. Computer network 90 comprises local machine 95 electrically coupled to network 96. Local machine 95 is electrically coupled to remote machine 94 and remote machine 93 via network 96. Local machine 95 is also electrically coupled to server 91 and database 92 via network 96. Network 96 may be a simplified network connection such as a local area network (LAN) or may be a larger network such as a wide area network (WAN) or the Internet. Furthermore, computer network 90 depicted in FIG. 1 is intended as a representation of a possible operating network that may contain the present invention and is not meant as an architectural limitation.

The internal configuration of a computer, including connection and orientation of the processor, memory, and input/output devices, is well known in the art. The present invention is a methodology that can be embodied in a computer program. Referring to FIG. 2, the methodology of the present invention is implemented on software by Character Conversion Program (CCP) 200. CCP 200 described herein can be stored within the memory of any computer depicted in FIG. 1. Alternatively, CCP 200 can be stored in an external storage device such as a removable disk or a CD-ROM. Memory 100 is illustrative of the memory within one of the computers of FIG. 1. Memory 100 also contains Unicode Translator Program 102 and Simplified Chinese/Traditional Chinese Conversion Table 104. The present invention may interface with Unicode Translator Program 102 and Simplified Chinese/Traditional Chinese Conversion Table 104 through memory 100. As part of the present invention, the memory 100 can be configured with CCP 200. Processor 106 can execute the instructions contained in CCP 200.

In alternative embodiments, CCP 200 can be stored in the memory of other computers. Storing CCP 200 in the memory of other computers allows the processor workload to be distributed across a plurality of processors instead of a single processor. Further configurations of CCP 200 across various memories are known by persons skilled in the art.

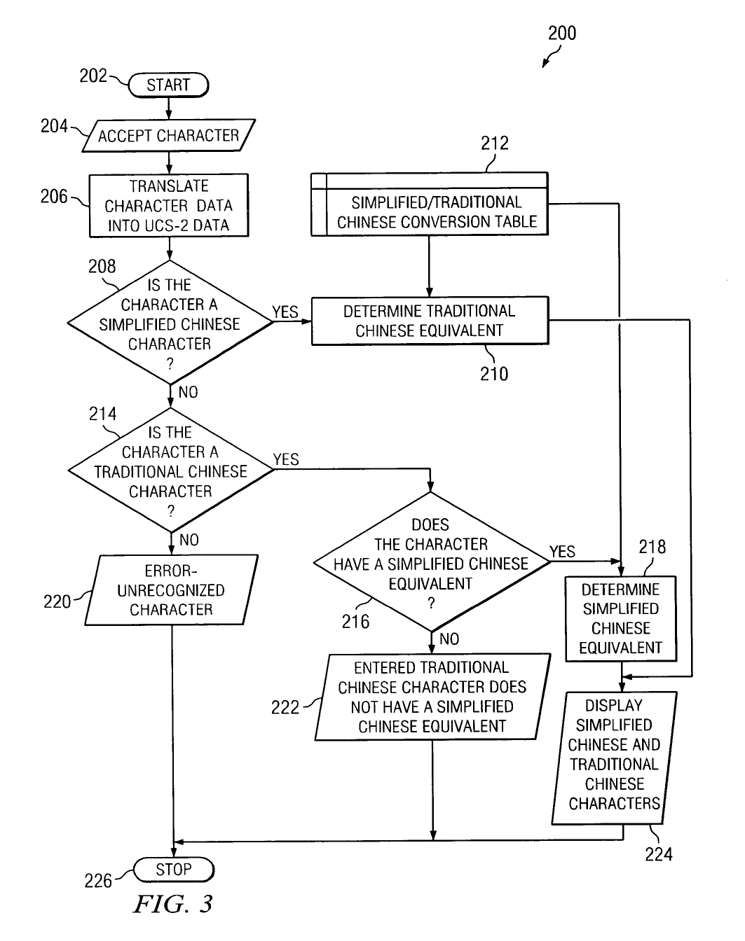

In the preferred embodiment, the present invention is a web page accessible from the Internet. A flowchart of the logic of CCP 200 of the present invention is illustrated in FIG. 3. CCP 200 is a program which translates a Simplified Chinese Character into a Traditional Chinese character and vice-versa. CCP 200 starts (202) when the user accesses the web page. The user then enters a Chinese character (204). The Chinese character entered at step 204 may be either a Traditional Chinese character or a Simplified Chinese character. Moreover, the input in step 204 may be in GB2312, Big 5, or any Unicode format. CCP 200 accepts GB2312, Big 5, or Unicode encoding (i.e. UTF-8) because CCP 200 translates the character data into UCS-2 data (206). CCP 200 may utilize Unicode translation Program 102 in FIG. 2 to translate the entered character into UCS-2 data. Although GB2312 and Big 5 are incompatible with each other, both GB2312 and Big 5 are compatible with Unicode. In other words, a web page encoded in GB2312 will not recognize Big 5 characters and a web page encoded in Big 5 will not recognize GB2312 characters. However, a web page encoded in Unicode will recognize both GB2312 characters and Big 5 characters because Unicode contains both the GB2312 characters and the Big 5 characters.

CCP 200 then makes a determination whether the entered character is a Simplified Chinese character (208). If the entered character is not a Simplified Chinese character, then CCP 200 proceeds to step 214. If the entered character is a Simplified Chinese character, then CCP 200 looks up the Simplified Chinese character in Simplified Chinese/Traditional Chinese Conversion Table 212 and determines the Traditional Chinese character equivalent (210). Simplified Chinese/Traditional Chinese Conversion Table 212 is a JAVA™ hashtable which references the Traditional Chinese characters to the Simplified Chinese characters, and vice-versa. Simplified Chinese/Traditional Chinese Conversion Table 212 may be like Simplified Chinese/Traditional Chinese Conversion Table 104 in FIG. 2. The data in the hashtable is in the UCS-2 Unicode format. Because there are about 1,250 Simplified Chinese characters, the hashtable contains approximately 2,500 entries—one for each Simplified Chinese character and the Traditional Chinese equivalent. CCP 200 then proceeds to step 224.

Returning to step 214, CCP 200 makes a determination whether the entered character is a Traditional Chinese character (214). If the entered character is not a Traditional Chinese character, then CCP 200 displays an error message that the entered character is not a recognized Simplified Chinese or Traditional Chinese character (220) and ends (226). If the entered character is a Traditional Chinese character, CCP 200 determines if the entered character has a Simplified Chinese equivalent (216). CCP 200 determines whether a Traditional Chinese character has a Simplified Chinese character equivalent by determining if the entered character is present in Simplified Chinese/Traditional Chinese Conversion Table 212. If the entered character does not have a Simplified Chinese equivalent, then CCP 200 displays a message indicating that the entered Traditional Chinese character does not have a Simplified Chinese equivalent (222) and ends (226). If the entered character does have a Simplified Chinese equivalent, then CCP 200 uses Simplified Chinese/Traditional Chinese Conversion Table 212 to determine the Simplified Chinese character equivalent (218) and proceeds to step 224.

At step 224, CCP 200 displays the entered character and the character equivalent (224). If the entered character was a Simplified Chinese character, then CCP 200 displays the entered Simplified Chinese character first and the Traditional Chinese character equivalent next to the entered Simplified Chinese character. Similarly, if the entered character was a Traditional Chinese character, then CCP 200 displays the entered Traditional Chinese character first and the Simplified Chinese character equivalent next to the entered Traditional Chinese character. CCP 200 then ends (226).

Turning to FIG. 4, an embodiment of Graphical User Interface (GUI) 300 of the present invention is illustrated. GUI 300 is an example of the contents of the web page embodiment of the present invention. GUI 300 is also an example of the display of the stand-alone computer program embodiment of the present invention which is operable on a single computer. GUI 300 contains a user input field 302. The user may input a character into user input field 302 utilizing the copy-and-paste operation of a computer. In a copy-and-paste operation, the user highlights the desired character, chooses “copy” from a menu, places the cursor in user input field 302, and selects “paste” from a menu. The highlighted character then appears in user input field 302. Persons of ordinary skill in the art are aware of methods for implementing copy-and-paste operations on a computer. The user may also input the character into user input field 302 by any method known by persons of ordinary skill in the art.

As part of the present invention, when the user utilizes the copy-and-paste operation to input a character into user input field 302, CCP 200 will recognize the entered character regardless of the encoding format used in the highlighted “copy” text. For example, a user may be viewing another web page written in Traditional Chinese and come across a character the user does not recognize. The user may then highlight the unrecognized character, copy the character, paste the character in user input field 302, and click submit button 304 to determine the Simplified Chinese character equivalent for the Traditional Chinese character. The present invention accepts the Big 5 encoding used in the other web page because Big 5 is compatible with Unicode. In another example, a user may be viewing another web page written in Simplified Chinese and come across a character the user does not recognize. The user may then highlight the unrecognized character, copy the character, paste the character in user input field 302, and click submit button 304 to determine the Traditional Chinese character equivalent for the Simplified Chinese character. The present invention accepts the GB2312 encoding used in the other web page because GB2312 is compatible with Unicode. If the present invention was implemented in either Big 5 or GB2312 encoding, the present invention would be limited to either Simplified Chinese or Traditional Chinese, depending on the encoding language.

After the user has inserted a character into user input field 302, the user may click submit button 304. Submit button 304 instructs CCP 200 to analyze the character in the user input field 302. As seen in FIG. 4, the user has input the Simplified Chinese character guó, which means country, state, or nation. CCP 200 displays the Simplified Chinese character 306 and the Traditional Chinese equivalent 308 below user input field 302. The user may input as many characters as desired and continue to utilize the present invention at will.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The novel spirit of the present invention is still embodied by reordering or deleting some of the steps contained in this disclosure. The spirit of the invention is not meant to be limited in any way except by proper construction of the following claims.

1. A method comprising: using Unicode to determine a Traditional Chinese character equivalent of a Simplified Chinese character.

2. The method of claim 1 further comprising: accepting the Simplified Chinese character as user input, wherein the Simplified Chinese character is encoded in GB2312 or Unicode.

3. The method of claim 1 further comprising: translating the Simplified Chinese character from GB2312 to Unicode.

4. The method of claim 1 further comprising: accessing a conversion table to determine the Traditional Chinese character.

5. The method of claim 4 wherein the conversion table is a JAVA hashtable.

6. The method of claim 1 wherein Traditional Chinese character is determined without the use of an intermediate language.

7. The method of claim 1 further comprising: displaying the Simplified Chinese character and the Traditional Chinese character.

8. A method comprising: using Unicode to determine a Simplified Chinese character equivalent of a Traditional Chinese character.

9. The method of claim 8 further comprising: accepting the Traditional Chinese character as user input, wherein the Traditional Chinese character is encoded in Big 5 or Unicode.

10. The method of claim 8 further comprising: translating the Traditional Chinese character from Big 5 to Unicode.

11. The method of claim 8 further comprising: accessing a conversion table to determine the Simplified Chinese character.

12. The method of claim 11 wherein the conversion table is a JAVA hashtable.

13. The method of claim 8 wherein Simplified Chinese character is determined without the use of an intermediate language.

14. The method of claim 8 further comprising: displaying the Traditional Chinese character and the Simplified Chinese character.

15. The method of claim 8 wherein the translating step further comprises:
determining if the Traditional Chinese character has a Simplified Chinese character equivalent;
responsive to a determination that the Traditional Chinese character has a Simplified Chinese character equivalent, using Unicode to determine a Simplified Chinese character equivalent of a Traditional Chinese character.

16. A program product operable on a computer, the program product comprising:
a computer-usable medium;
wherein the computer usable medium comprises instructions comprising:
instructions for using Unicode to determine a Traditional Chinese character equivalent of a Simplified Chinese character.

17. The program product of claim 16 further comprising: instructions for accepting the Simplified Chinese character as user input, wherein the Simplified Chinese character is encoded in GB2312 or Unicode.

18. The program product of claim 16 further comprising: instructions for translating the Simplified Chinese character from GB2312 to Unicode.

19. The program product of claim 16 further comprising: instructions for accessing a conversion table to determine the Traditional Chinese character.

20. The program product of claim 19 wherein the conversion table is a JAVA hashtable.

21. The program product of claim 16 wherein Traditional Chinese character is determined without the use of an intermediate language.

22. The program product of claim 16 further comprising: instructions for displaying the Simplified Chinese character and the Traditional Chinese character.

23. A program product operable on a computer, the program product comprising:
a computer-usable medium;
wherein the computer usable medium comprises instructions comprising:
instructions for using Unicode to determine a Simplified Chinese character equivalent of a Traditional Chinese character.

24. The program product of claim 23 further comprising: instructions for accepting the Traditional Chinese character as user input, wherein the Traditional Chinese character is encoded in Big 5 or Unicode.

25. The program product of claim 23 further comprising: instructions for translating the Traditional Chinese character from Big 5 to Unicode.

26. The program product of claim 23 further comprising: instructions for accessing a conversion table to determine the Simplified Chinese character.

27. The program product of claim 26 wherein the conversion table is a JAVA hashtable.

28. The program product of claim 23 wherein Simplified Chinese character is determined without the use of an intermediate language.

29. The program product of claim 23 further comprising: instructions for displaying the Traditional Chinese character and the Simplified Chinese character.

30. The program product of claim 23 wherein the translating step further comprises:
instructions for determining if the Traditional Chinese character has a Simplified Chinese character equivalent;
responsive to a determination that the Traditional Chinese character has a Simplified Chinese character equivalent, instructions for using Unicode to determine a Simplified Chinese character equivalent of a Traditional Chinese character.
